(19) United States
(12) Patent Application Publication
(10) Pub. No.: US 2002/0121966 A1
(43) Pub. Date: Sep. 5, 2002

(54) Piezoelectric transducer for vibrational alert and sound in a personal communication device

(76) Inventors: Stanley E. Woodard, Hampton, VA (US); Robert L. Fox, Hayes, VA (US); Robert G. Bryant, Lightfoot, VA (US)

Correspondence Address: KURT G. HAMMERLE, NASA LANGLEY RESEARCH CENTER, MAIL STOP 212, 3 LANGLEY BOULEVARD, HAMPTON, VA, 23681-2100, US

(21) Appl. No.: 09/753,370

(22) Filed: Jan. 2, 2001

(51) Int. Cl. G08B 3/10

(52) U.S. Cl. 340/384.6; 340/384.1

(57) ABSTRACT

A personal communication device comprises a housing, a receiver component, a processor and a multi-functional piezoelectric transducer. The transducer is mounted within the housing, is electrically connected to the processor, and produces mechanical vibrations in response to the electrical signals transmitted by the processor. These mechanical vibrations are over a broad range of frequencies and are of a force sufficient to generate a tactile alert, an audible alert, and audible sound over the audible frequency range.

The transducer comprises a piezoelectric component and an acoustic member attached to one of the surfaces of the piezoelectric component. The piezoelectric component may comprise either an unimorph or a bimorph structure including a piezoceramic wafer made of lead zirconate titanate and a layer of dampening material sandwiched between the piezoelectric component and the acoustic member.

The acoustic member comprises a surrounding wall portion and an end portion which form an acoustic chamber when the member is mounted on a surface of the piezoelectric component. The end portion has an orifice to form a passageway from the chamber through the end portion to the outside of the member.

### ORIGIN OF THE INVENTION

The invention described herein was made by employees of the United States Government and may be used by or for the Government for governmental purposes without the payment of any royalties thereon or therefor.

### BACKGROUND OF THE INVENTION

The present invention relates to personal communication devices, and more particularly, to a vibrational and acoustic piezoelectric transducer for use with personal communication devices.

Vibrating alarms for use with personal communication devices are well known in the art. Many of these alarms comprise conventional motors having an eccentric weight attached to the rotor shaft. Accordingly, when the motor is activated, the rotation of the rotor shaft and corresponding rotation of the eccentric weight causes vibration within the personal communication device that is detected by the holder of the device. Typically, such vibrating alarms are not capable of also producing an acoustic signal; or if the vibrating alarm is capable of producing an acoustic signal, the design does not reproduce audible sound over the full audible frequency range.

Accordingly, a need exists for a combination vibrating alarm and acoustical sound device that has a relatively uncomplicated design, is relatively inexpensive to produce, that is substantially durable and is suited (relatively lightweight and small) to be incorporated into a hand-held, personal communication device.

### SUMMARY OF THE INVENTION

Accordingly, an object and advantage of the present invention is to provide a vibrating piezoelectric transducer for a personal communication device that is easily manufactured, requires a small amount of power to operate, and provides the desired amount of vibration for transmitting vibrational and acoustic signals.

According to the present invention, the foregoing and other objects and advantages are attained by providing a personal communication device comprising a housing, a receiver component, a processor and a multi-functional piezoelectric transducer. The receiver component is mounted within the housing and receives signals transmitted to the device. The processor is also mounted within the housing and is operatively coupled to the receiver component. The processor processes signals received by the receiver component and sends electrical signals to the multi-functional piezoelectric transducer. The piezoelectric transducer is also mounted within the housing and is electrically connected to the processor. The piezoelectric transducer produces mechanical vibrations in response to the electrical signals transmitted by the processor. These mechanical vibrations, which are over a broad range of frequencies, are of a force sufficient to generate a tactile alert at a predetermined first frequency, to generate an audible alert at frequencies within a second predetermined range, and to generate audible sound over the audible frequency range. These vibrations also produce a substantially flat audio response over the audible frequency range.

In an alternate embodiment, the personal communication device further comprises an audible alerting component, such as a speaker. The audible alerting component is operatively connected to the processor or to the control switch and is located within the housing. The audible alerting component vibrates at frequencies within a predetermined range so as to produce an audible, alerting sound to a user of the device. Under this embodiment, the multi-functional piezoelectric transducer still has the capability of producing an audible alert. However, the processor does not send the audible alerting signal to the multi-functional piezoelectric transducer, but rather sends it to the audible alerting component.

In an alternate embodiment, the device further comprises a power supply, operatively coupled to the processor, for supplying a voltage sufficient to cause the multi-functional piezoelectric transducer to vibrate as needed. In another alternate embodiment, the processor includes a power supply for supplying the required voltage. In yet another alternate embodiment, the device further comprises an output component, an amplifier, a control switch, and a clamp. The output component is connected to the housing and is operatively coupled to the processor. This output component visually displays signals processed by the processor, such as a phone number or other images. The amplifier is operatively coupled to the processor and amplifies electrical signals processed by the processor before they are sent to the multi-functional piezoelectric transducer. The clamp attaches to one end of the multi-functional piezoelectric transducer and mounts it within the housing, preferably in a cantilever fashion. The control switch is operatively connected to the processor or to the transducer and enables the user of the personal communication device to select the type of alert, vibrational or acoustic, which is given to a user of the device.

In accordance with another aspect of the present invention, a device for producing mechanical vibrations in response to an electrical signal comprises a piezoelectric component and at least one acoustic member attached to one of the surfaces of the piezoelectric component. The piezoelectric component has two opposing surfaces and at least two points where polarity is recognized. In an alternate embodiment, the piezoelectric component has a neck region where a clamp couples the piezoelectric component to a base. The piezoelectric component may comprise either an unimorph or a bimorph structure including a piezoceramic wafer made of lead zirconate titanate. In yet another alternate embodiment, the device for producing mechanical vibrations further comprises a dampening material, such as a polyolefin with an adhesive layer, sandwiched between the piezoelectric component and the acoustic member. In another embodiment, the dampening material may comprise a layer which attaches to substantially the entire top surface of the piezoelectric component.

In another aspect of the present invention, an acoustic member comprises a surrounding wall portion and an end portion. The surrounding wall portion has a bottom surface and a top surface. The top surface extends along a direction substantially perpendicular from the bottom surface to the top. The end portion is connected to the top surface of the surrounding wall portion. When the bottom surface of the acoustic member is attached to a surface of the piezoelectric component, the member forms an acoustic chamber. Essentially, the acoustic member is similar in structure to a bucket or open-ended barrel. The end portion has an orifice to form a passageway from the chamber through the end portion to outside the confines of the member.

Still other advantages of the present invention will become readily apparent to those skilled in the art from the following drawings and detailed description. As will be realized, the invention is capable of modifications in various obvious respects, all without departing from the invention. Accordingly, the drawings and description are to be regarded as illustrative in nature, and not as restrictive.

### BRIEF DESCRIPTION OF THE DRAWINGS

FIG. 1 is a schematic, block diagram representing a personal communication device comprising a multi-functional transducer in accordance with the present invention;

FIG. 2 is a schematic, block diagram representing an alternate device comprising a multi-functional transducer in accordance with the present invention;

FIG. 3 is a side view of a first embodiment of the multi-functional transducer of the present invention;

FIG. 4 is a perspective view of the transducer of FIG. 3;

FIG. 5 is a side view of a unimorph piezoelectric structure;

FIG. 6 is a side view of a bimorph piezoelectric structure;

FIG. 7 is a side view of a second embodiment of the multi-functional transducer of the present invention;

FIG. 8 is a perspective view of the transducer of FIG. 7;

FIG. 9A shows the mode shape of a rectangular piezoelectric component mounted in a cantilever fashion vibrating at a natural frequency of 270 Hz;

FIG. 9B shows the mode shape of a rectangular piezoelectric component mounted in a cantilever fashion vibrating at a natural frequency of 765 Hz;

FIG. 10 illustrates the anti-node lines and node lines of the component of FIG. 9A;

FIG. 11 is a side view of a third embodiment of the multi-functional piezoelectric transducer of the present invention;

FIG. 12 is a top view of a third embodiment of the multi-functional piezoelectric transducer of the present invention;

FIG. 13 A is a top view of a variable mounting system in accordance with the present invention;

FIG. 13B is a cross-sectional side view along the line B-B of FIG. 13A;

FIG. 13C is an end view of a variable mounting system in accordance with the present invention;

FIG. 14A is a top view of an alternate embodiment of the variable mounting device of the present invention;

FIG. 14B is a cross-sectional side view along the line B-B of FIG. 14A;

FIG. 14C is an end view of an alternate embodiment of the variable mounting device of the present invention;

FIGS. 15A-F illustrate mode shapes of a T-shaped piezoelectric component at six different natural frequencies;

FIG. 16 illustrates the anti-node lines and node lines of the component of FIG. 15F;

FIG. 17 illustrates a super imposition of the anti-node points or lines of the component of FIG. 15;

FIG. 18A is a cross-sectional side view of an acoustic member in accordance with the present invention;

FIG. 18B is a top view of the acoustic member of the present invention;

FIG. 19 is another cross-sectional view of the acoustic member of the present invention;

FIG. 20 is top view of a bimorph piezoelectric transducer having a T-shaped planform in accordance with one of the best modes for carrying out the invention;

FIG. 21 is a cross-sectional side view of a unimorph piezoelectric transducer having a T-shaped planform in accordance with another one of the best modes for carrying out the invention.

### DETAILED DESCRIPTION

A. Personal Communication Device

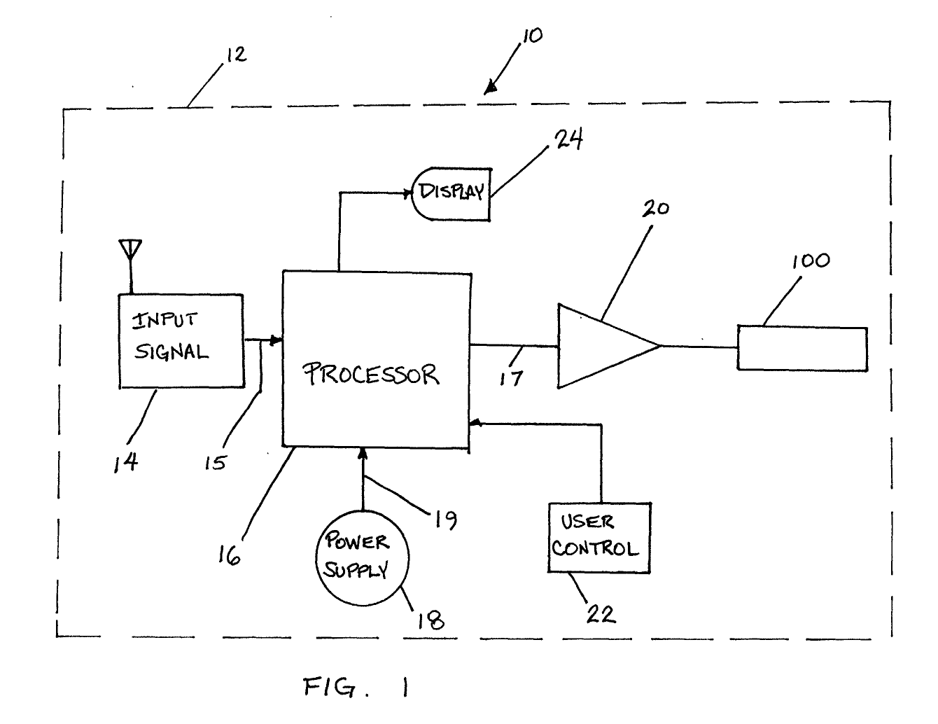

Referring now to FIG. 1, a schematic block diagram representation of a personal communication device 10 is shown incorporating a multi-functional piezoelectric transducer 100 in accordance with the present invention. The personal communication device 10 includes a housing 12, a receiver component 14 for receiving an input signal, and a processor 16 having a power supply 18. In an alternate embodiment, the device 10 further comprises an amplifier 20, a user control switch 22, and an output component or display 24.

The device 10 may be one of various types of personal communication devices, such as a cellular telephone, a walkie-talkie or other two-way radio, a pager, or any other device where tactile alert and communication of sound is desired. Examples also include the personal communication devices described in U.S. Pat. No. 5,172,092 to Nguyen et al. and in U.S. Pat. No. 5,780,958 to Strugach et al., the disclosures of both being incorporated herein by reference. The housing 12 is fabricated from a lightweight, durable material such as Acrylonitrile-Butadiene-Styrene (ABS) plastic. The receiver component 14 is mounted within the housing 12 and receives signals transmitted to the device 10. The receiver 14 may be one of various well-known receivers in the art, such as a radio frequency (RF) antenna, an infrared sensor, or a related reception device.

The processor 16 is also mounted within the housing 12, is operatively coupled to the receiver component 14, and is electrically connected to the multi-functional transducer 100. The processor 16 processes signals 15 received by the receiver component 14 and transmits a processed electrical signal 17 to the multi-functional transducer. The processor 16 also typically functions as a computer or controller to perform other processing functions.

In one embodiment, the processor 16 includes a power supply 18 for supplying a voltage 19 sufficient to cause the multi-functional piezoelectric transducer 100 to vibrate as needed. Alternatively, the power supply 18 may be a separate component, operatively connected to the processor, for supplying the required voltage. The power supply may comprise a battery, a solar cell, or any other means for providing power to the various components of the personal communication device.

Continuing to refer to FIG. 1, an alternate embodiment of the personal communication device 10 further comprises an amplifier 20 operatively coupled to the processor 16. The amplifier 20 amplifies the electrical signal 17 transmitted by the processor before it is sent to the piezoelectric transducer 100. The device 10 also comprises a user control switch 22 which is operatively coupled to the processor 16 as shown or the output of the amplifier 20 (not shown) before input to the transducer 100. The control switch 22, which may be maneuvered mechanically or electrically, enables the user of the device 10 to select the type of alert, tactile (vibrational) or audio (sound), which is to be provided to the user. The switch 22 can be controlled manually by a user or electrically by the processor 16. This alternate embodiment further comprises an output component or display 24 which is operatively coupled to the processor 16. The display 24 visually outputs electrical signals processed by the processor 16. Examples of various types of display 24 include a liquid crystal display (LCD) for displaying the incoming telephone number and other messages being received by the receiver component 14 or a light emitting diode (LED) for displaying the presence of an input signal being received by the receiver component 14. Display 24 may also include a flat-panel display for outputting video images so as to enable videoconferencing.

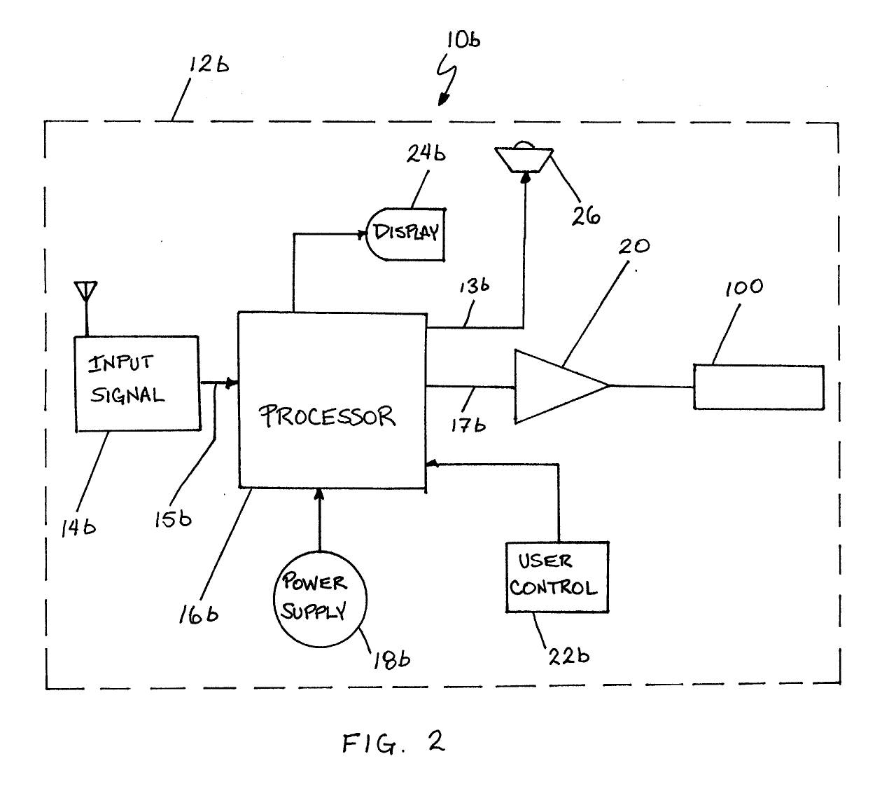

Referring now to FIG. 2, an alternate embodiment of a personal communication device 10b is shown. In this embodiment, the device 10b comprises a housing 12b, a receiver component 14b, a processor 16b, a power supply 18b, an amplifier 20b, a control switch 22b, and a display 24b. These components 12b-24b are operatively coupled to each other in a manner substantially similar to the manner described for the similarly numbered components of device 10 in FIG. 1. The device 10b further comprises an audible alerting component 26 which is operatively coupled to the processor 16b and is located within the housing 12b. The audible alerting component 26 is typically a moving-coil loudspeaker and vibrates within a predetermined range of frequencies so as to produce an audible, alerting sound to a user of the device 10b. With this embodiment, the multi-functional transducer 100 still has the capability of providing an audible alert. However, the processor 16b does not send the audible alerting signal 13b to the transducer 100, but rather sends the signal 13b to the alerting component 26. This embodiment enables the audible alerting component 26 to be located within the housing 12b at a location separate from the component used to generate audible sound over the audible frequency range. As is understood by the skilled artisan, current FCC regulations require such a separate location for the audible alerting component.

B. Multi-Functional Piezoelectric Transducer

The piezoelectric transducer of the present invention has the capability of performing tactile alert, audio alert, and a substantially flat audio or sound pressure level response over the audible frequency range. This multi-functional transducer may be selected to perform any one or any combination of these three functions in a personal communication device as previously described in Section A. Alternatively, the multi-functional transducer may be selected to perform any one or combination of these three functions in other devices, such as conventional telephones, loudspeakers, radios, or other devices wherein a transducer for providing mechanical vibrations in response to an electrical signal is desired.

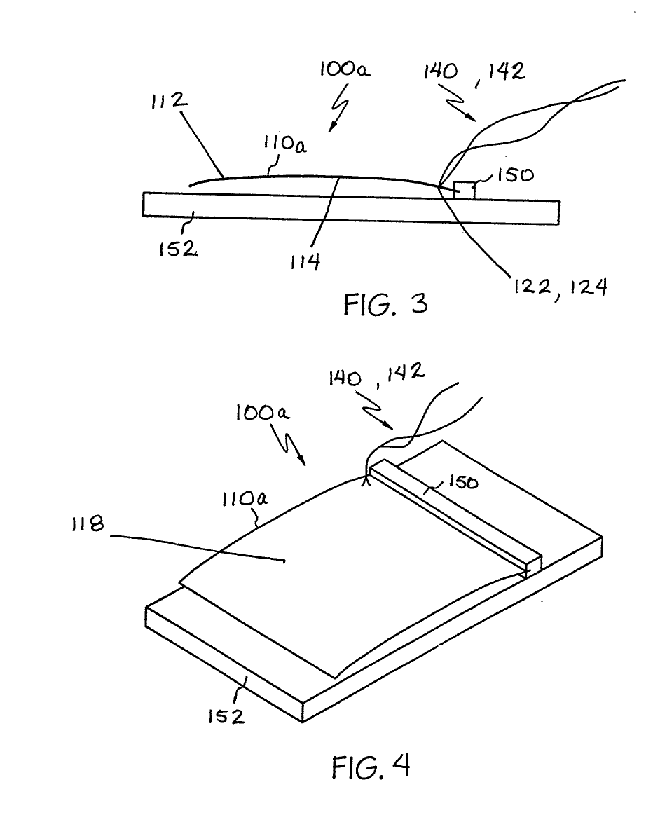

Referring now to FIGS. 3 and 4, one embodiment of the multi-functional piezoelectric transducer 100 comprises the assembly 100a. The transducer assembly 100a produces mechanical vibrations in response to the electrical signals 17 transmitted by the processor 16 and typically amplified by the amplifier 20. The mechanical vibrations of the transducer assembly 100a are of sufficient force to generate a tactile alert at a predetermined first frequency, to generate an audible alert within a predetermined range of frequencies, and to generate sound over the audible frequency range.

As shown in FIGS. 3 and 4, the transducer assemblylOOa comprises a piezoelectric component 110a having two opposing surfaces 112 and 114 and at least two points 122 and 124 where polarity is recognized. The two points 122,124 coincide with the points of attachment of two electrical leads or electrodes 140 and 142. The multi-functional transducer assembly 100a further comprises a clamp 150 which is positioned at one end of the piezoelectric component 110a. The clamp 150 is rigidly attached to a sounding board 152, which may be unitary with, or otherwise rigidly attached to, the housing 12 of the personal communication device. The clamp 150 thereby mounts the transducer piezoelectric component 110a within the housing. As shown in FIGS. 3 and 4, the component 110a is mounted in a cantilever fashion.

The component 110a is a planar wafer 118 which is substantially rectangularly shaped. However, as will be appreciated by those of ordinary skill in the art, the wafer may take other shapes, such as triangular, square, circular, or trapezoidal. Another example of the various shapes of the piezoelectric component includes the T-shape of component 110c shown in FIG. 12. The piezoelectric components 110a and 110c comprise a piezoelectric wafer having a layer of electroactive material such as lead zirconate titanate (PZT). The electroactive material responds to an electric field by developing a strain.

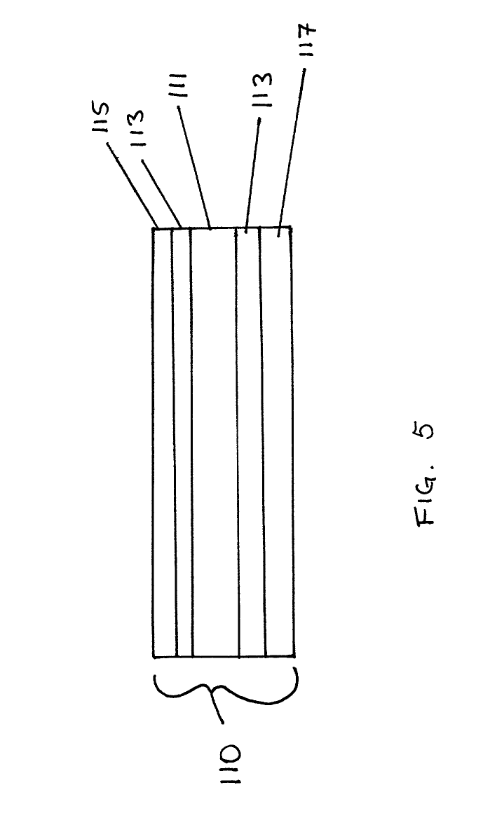

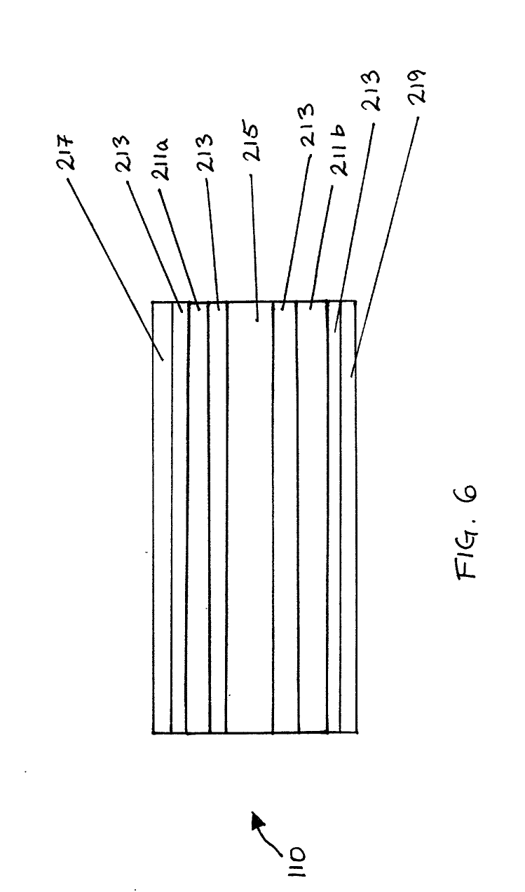

The piezoelectric components 110a and 110c may comprise several different monolithic or segmented structures. An example of a monolithic, unimorph piezoelectric structure is shown in FIG. 5. An electroactive material 111 is bonded with an electrically conductive epoxy 113 to two support layers 115 and 117. An example of a monolithic, bimorph piezoelectric structure is shown in FIG. 6. In this embodiment, two layers of an electroactive material 211a, 211b are bonded with an electrically conductive epoxy 213 to an inner metallic support layer 215 and two outer support layers 217, 219. Examples of other monolithic structures for the piezoelectric components 110a, 110c include the “Thin-Layer Composite Unimorph Ferroelectric Driver and Sensor” disclosed in U.S. Pat. No. 5,632,841, which is hereby incorporated by reference, other prestressed unimorph or bimorph structures, and the “Packaged Strain Actuator” disclosed in U.S. Pat. No. 5,687,462, which is hereby incorporated by reference. An example of a segmented or fiber-like piezoelectric structure is disclosed in U.S. Pat. No. 5,869,189, which is hereby incorporated by reference.

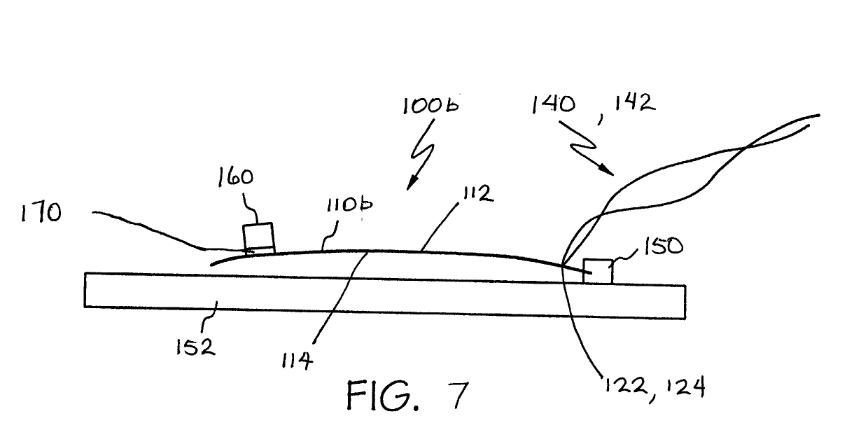

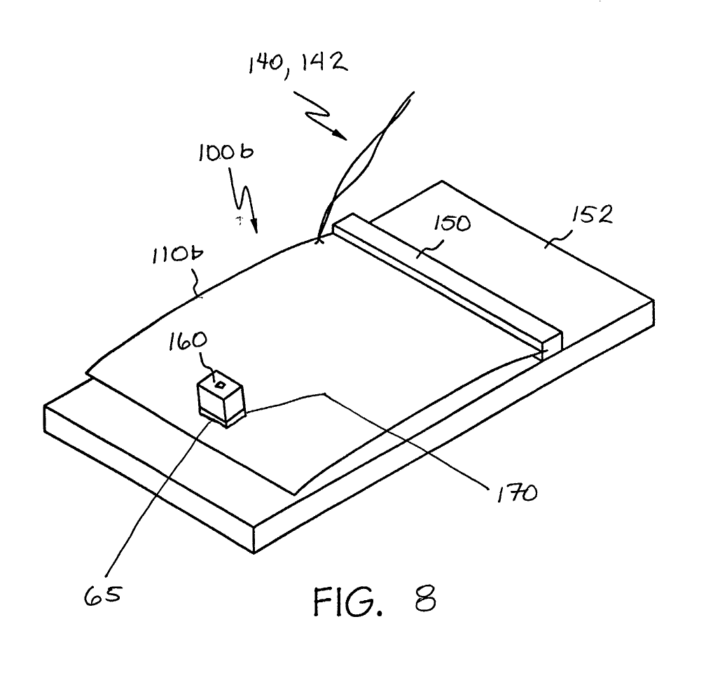

Another embodiment of the multi-functional piezoelectric transducer 100 comprises the assembly 100b shown in FIGS. 7 and 8. The transducer assembly 100b also produces mechanical vibrations of sufficient force to generate a tactile alert, an audible alert, and audible sound over the audible frequency range. With this alternate embodiment, the transducer assembly 100b comprises the piezoelectric component 110bhaving two opposing surfaces 112, 114 and at least two points where polarity is recognized 122,124. The multi-functional transducer assembly 100b further comprises a clamp 150 positioned at one end of the piezoelectric component 110b to mount the component within the housing 12 in a cantilever fashion.

The multi-functional transducer assembly 100b further comprises at least one acoustic member 160 attached to the surface 112. Alternatively, the transducer assembly 100b further comprises a dampening material 170 positioned between the piezoelectric component 110 and the at least one acoustic member 160, or the dampening material 170, as shown in FIG. 21, may extend over substantially the entire surface 112 of the piezoelectric component. Preferably, the dampening material 170 has a combination of flexure, dampening, and adhesive characteristics. An example of a material providing such characteristic is 3M Scotch™ 859 Removable Mounting Squares. This material comprises a layer of synthetic polyolefin. The material further comprises a thin adhesive layer to affix the acoustic member 160. Another example of a dampening material providing dampening and adhesive characteristics is 3M Scotch™ 468 MP Hi Performance Adhesive. Both of these materials provide beneficial acoustic and dynamic coupling properties.

In one aspect of the transducer assembly 10b, the acoustic member 160 is attached to the surface 112 of the piezoelectric component at an anti-node point 65, also known as a peak out-of-plane displacement point, of the piezoelectric component. Alternatively, the acoustic member 160 is affixed to the surface along the fundamental and/or non-fundamental resonant vibration anti-node lines. Both the anti-node points and the anti-node lines of the piezoelectric component are determined by understanding the natural modes of vibration of the component.

The natural modes of vibration of any structure, including the component 1110b, is the manner of vibration associated with each particular natural frequency. The natural frequency of a structure is known as the frequency of free vibration. When a structure is subjected to an external force that is synchronized with a natural frequency, the structure enters a state known as resonance. Each state of resonance has a unique natural frequency value and a deformed configuration, known as a mode shape. The natural frequency of vibration having the lowest value is known as the fundamental mode of vibration. All other natural frequencies are known as non-fundamental modes of vibration.

When the component 110b is energized by an electrical signal at a particular natural frequency, the component harmonically and cyclically alternates between a deformed and an undeformed configuration as it vibrates. This alternating between deformed and undeformed configurations results in portions of the component moving perpendicular to the plane formed by a stationary, unenergized component, also known as an out-of-plane displacement. For any given resonance during vibration, one may determine either lines (anti-node lines) or points (anti-node points) that have peak out-of-plane displacements relative to other portions of the component. On the other hand, one may also determine either points or lines having minimal out-of-plane displacements relative to other portions of the component, which are known as node points or node lines. One aspect of the present invention seeks to take advantage of these vibrational attributes of the component by placing and affixing the acoustic members 160 along or at the anti-node lines or anti-node points of the piezoelectric component.

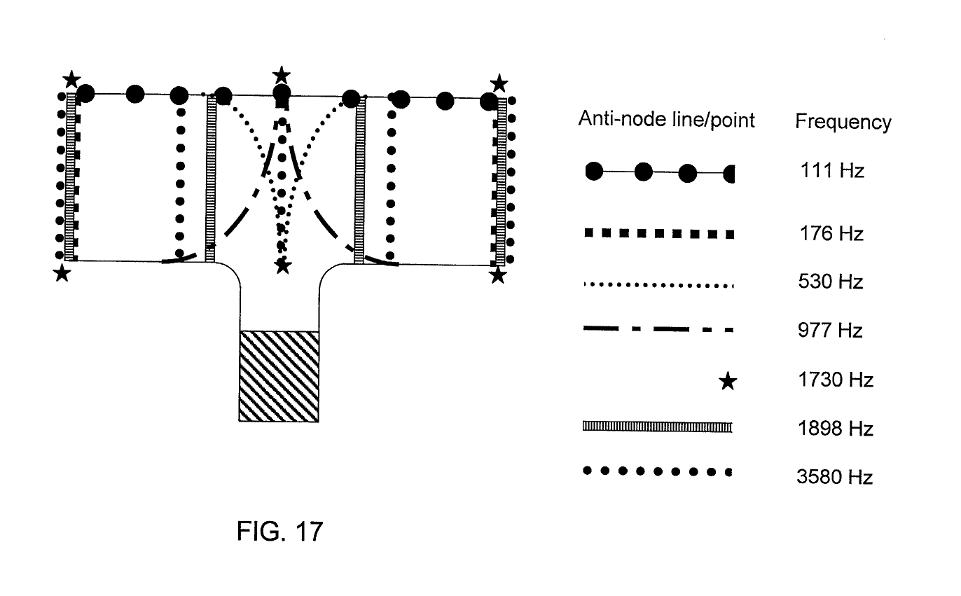

The method of determining the best location or locations for affixing an acoustic member requires superimposing the anti-node points and anti-node lines for the fundamental and non-fundamental modes of vibration. For example, FIG. 17 illustrates a superimposition of the anti-node points and lines of a T-shaped piezoelectric component 110c, which will be discussed further shortly. When two or more mode shapes share a common anti-node line or point, at least one acoustic member is placed along the common line or point. This placement takes advantage of the relatively higher out-of-plane displacement so as to produce a substantially flat sound pressure level in response to the inputted voltage across the audible frequency range.

As is understood by the skilled artisan, various techniques are available for determining the location of an anti-node point 65 or a collection of anti-node points, known as an anti-node line, of a wafer having a substantially planar geometry like the component 110b. Examples of these techniques include a strobe light, laser holography, shearography, and laser vibrometry. These techniques provide the mode shapes of a piezoelectric component.

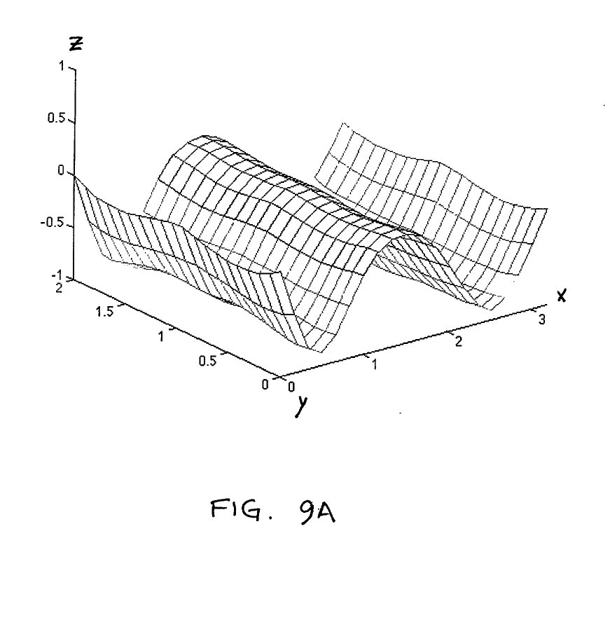

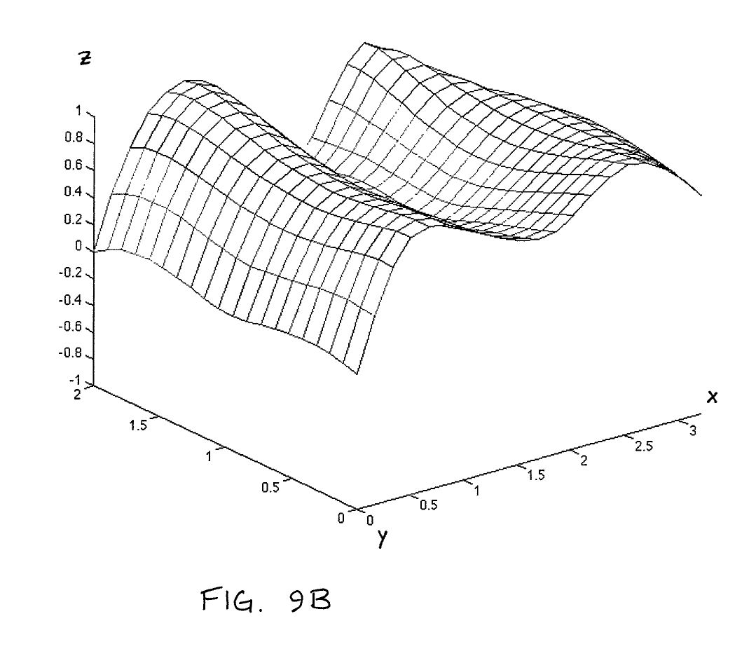

Examples of the mode shapes of a rectangularly-shaped planar piezoelectric component, such as components 110a or 110b, are shown in FIGS. 9A and 9B for the two natural frequencies of 270 Hz and 765 Hz, respectively. The component was 1.75 inches wide, 3.0 inches long, and was made using the process disclosed in U.S. Pat. No. 5,632,841. During the vibrational analysis, the component was mounted in a cantilever fashion along a cantilever line which is parallel to the y-axis shown. The relative out-of-plane displacement of the component is represented along the z-axis. FIG. 10 illustrates the anti-node lines 67, or lines of peak out-of-plane displacement, and the node lines 69 of the component of FIG. 9A at the natural frequency of 270 Hz when mounted at the cantilever line 71. Accordingly, the examination of the modes of vibration of a particular piezoelectric component enables one to determine the anti-node points or lines and position an acoustic member accordingly.

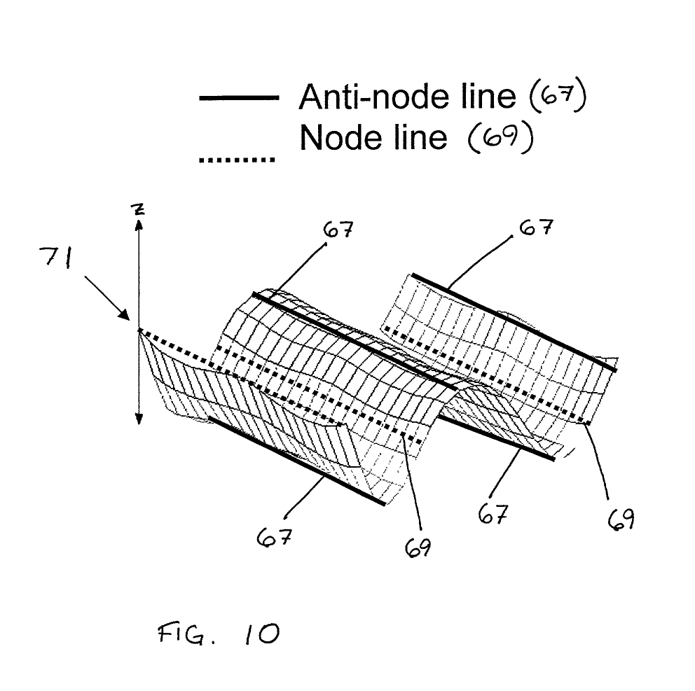

Referring now to FIGS. 11 and 12, a third embodiment of the multi-functional piezoelectric transducer 100 is shown comprising assembly 100c. Assembly 100c produces mechanical vibrations of sufficient force to generate a tactile alert, an audible alert, and audible sound over the audible frequency range. Under this embodiment, the transducer assembly comprising the piezoelectric component 110c again has two opposing surfaces 112, 114 and at least two points where polarity is recognized 122, 124. As shown in the top view of FIG. 12, the piezoelectric component 1 Oc has a T-shaped geometry or planform which comprises a crossbar region 308 and a neck region 310 extending from one side of the piezoelectric component. The neck region 310 is operatively connected to a clamp 150, which couples the component 110c to the sounding board 152. Again, the sounding board 152 may be unitary with, or otherwise rigidly attached to, the housing 12 of the personal communication device. The clamp 150 couples the component 110c to the sounding board 152 in a cantilever fashion.

Although a clamp is illustrated in FIGS. 11 and 12, it is to be understood, as will be appreciated by those of ordinary skill in the art, that other means for connecting the piezoelectric component (110a, 110b or 110c) to the sounding board 152 in a cantilever fashion may also be used. Such means for connecting would include a bracket with a retaining screw, two or more clamps, or a mounting system which can vary the mounting position and vibrational area of the component by adjusting the mounting location of the component.

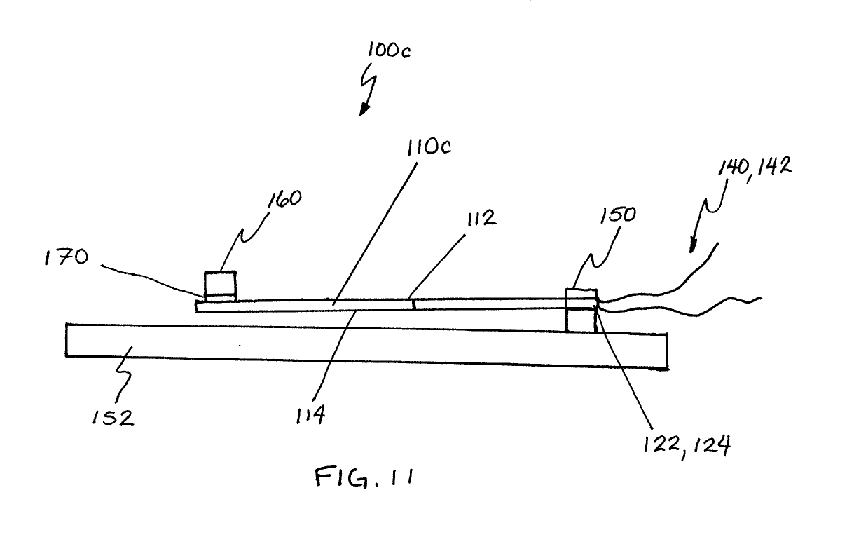

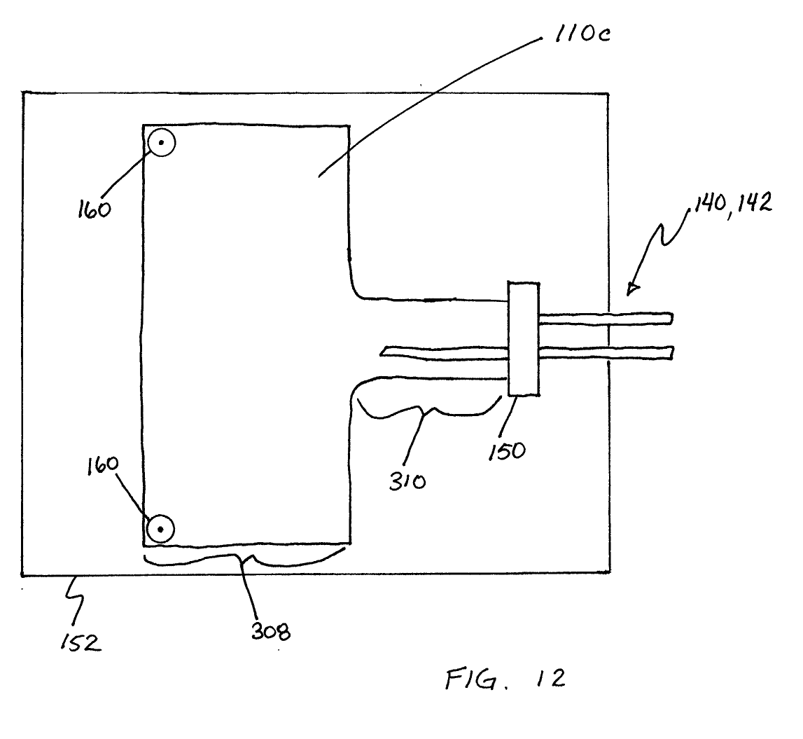

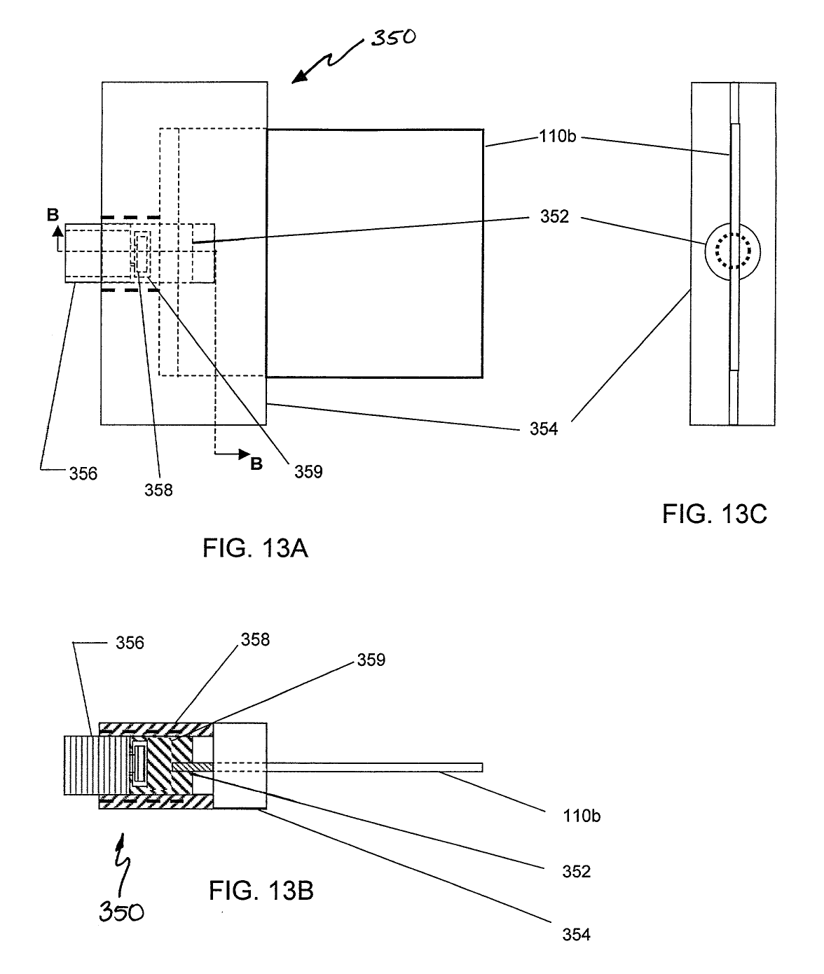

An example of a variable mounting system 350 is shown in FIGS. 13A-C for a rectangularly-shaped component 110b. The variable mounting system 350 comprises a variable position clamp 352 and a mounting sleeve 354. The threaded clamp 352 comprises an adjustment screw 356 including an adjustment screw key 358 which fits within an adjustment screw key slot 359. The adjustment screw 356 may be turned to adjust the exposed length of the component 10b as it extends away from the mounting sleeve 354. Variations in the vibrational area of the component 110b has an impact on the modal dynamics of the component. The variable mounting system 350 is used primarily to alter the bending modes of vibration of the component.

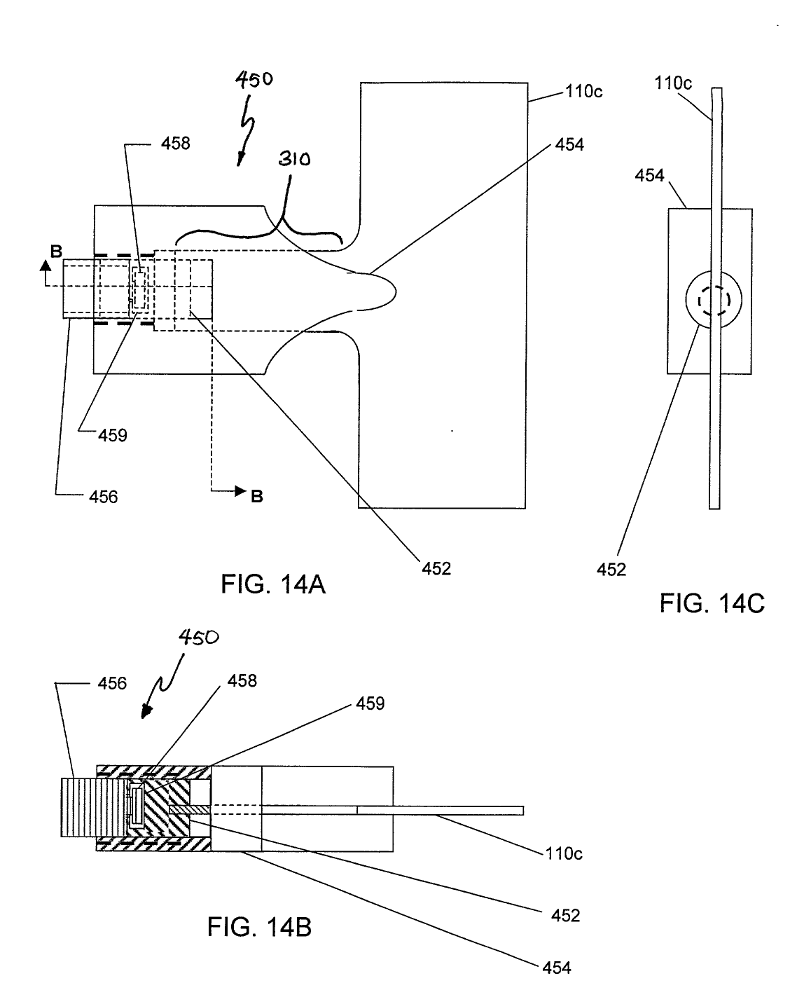

An example of a variable mounting assembly 450 for a T-shaped component 110c is shown in FIGS. 14A-C for varying the mounting location of the component 110c along the neck region 310. The variable mounting assembly 450 comprises a variable position clamp 452 and a mounting sleeve 454. The threaded clamp 452 comprises an adjustment screw 456 including an adjustment screw key 458 which fits within an adjustment screw key slot 459. The adjustment screw 456 may be turned to adjust the exposed length of the component 110c as it extends away from the mounting sleeve 454. Variations in the vibrational area of the component 110c has an impact on the modal dynamics of the component. The variable mounting assembly 450 is used to alter the torsion and bending modes of vibration of the component 110c.

As can be seen in FIGS. 11 and 12, the component 110c further comprises at least one acoustic member 160 attached to the surface 112 by an adhesive, flexible dampening material 170. Again, an example of such a dampening material includes 3M Scotch™ 859 Removable Mounting Squares. The acoustic members 160 may be located at an anti-node point or line of the component 110c.

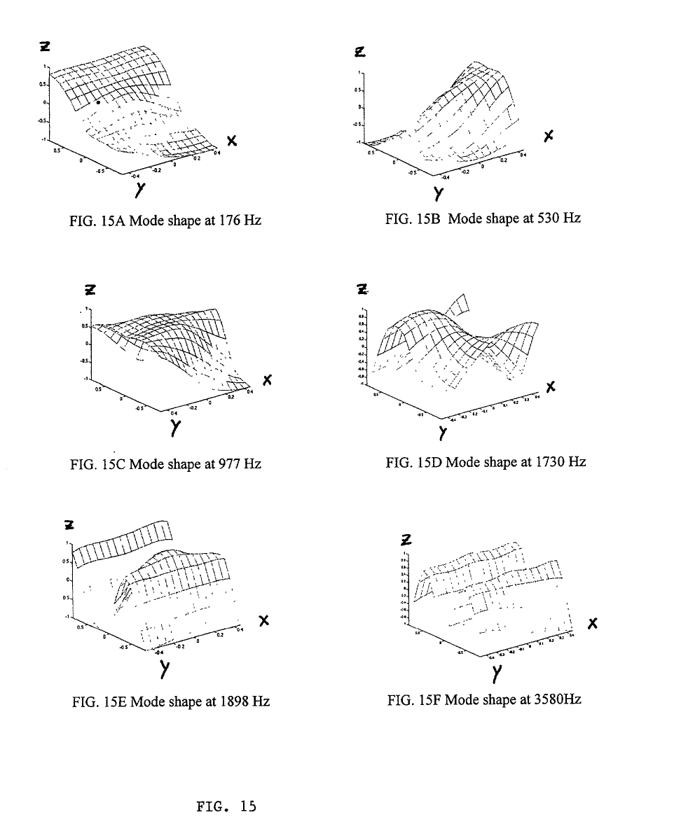

As discussed earlier, anti-node points or lines are determined by measuring the vibrational characteristics of the piezoelectric component. Examples of the mode shapes for the T-shaped planar piezoelectric component 110c are shown in FIGS. 15A-15F for six different natural frequencies of 176 Hz, 530 Hz, 977 Hz, 1730 Hz, 1898 Hz, and 3580 Hz, respectively. During the vibrational analysis, the component was mounted in a cantilever fashion along a cantilever line which is parallel to the y-axis shown. The zero value of the x-axis indicates the point where the neck region 310 of the component ends and the crossbar region 308 of the component 110c begins. The relative out-of-plane displacement of the component is represented along the z-axis.

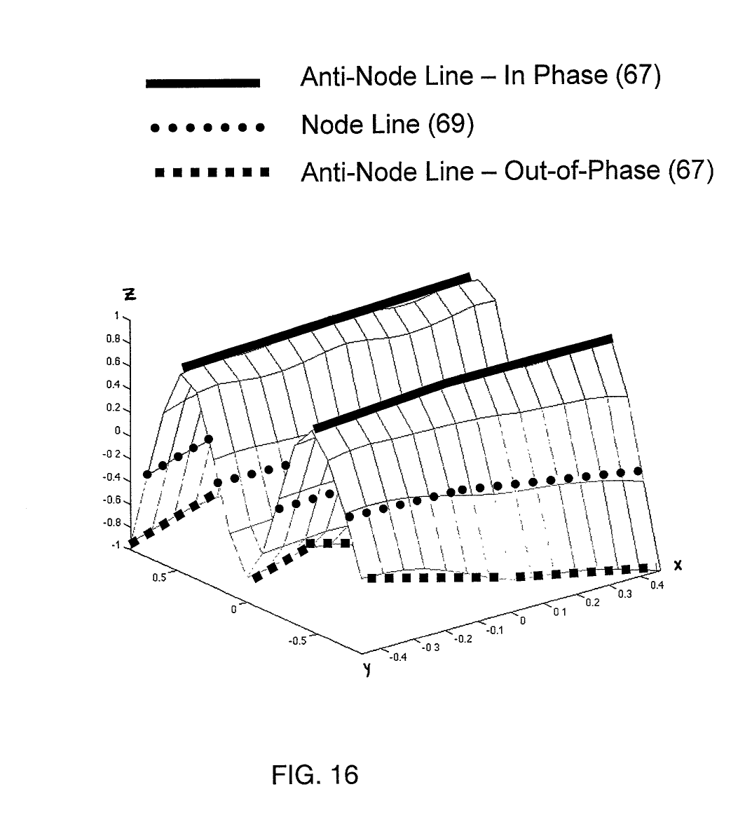

FIG. 16 illustrates the anti-node lines 67 and node lines 69 for the component 110c of FIG. 15F at a frequency of 3580 Hz. As discussed earlier, the method of determining the best location or locations for affixing an acoustic member requires superimposing the ani-node points and anti-node lines for the fundamental and non-fundamental modes of vibration. FIG. 17 illustrates a superimposition of the anti-node points and lines of the T-shaped piezoelectric component 110c for the fundamental frequency (or first natural frequency) of 111 Hz and six non-fundamental frequencies of 176 Hz, 530 Hz, 977 Hz, 1730 Hz, 1898 Hz, and 3580 Hz. When two or more mode shapes share a common anti-node line or point, at least one acoustic member is placed along the common line or point to take advantage of the broader frequency range of relatively higher out-of-plane displacement. One objective is to produce a substantially flat audio output (i.e., sound pressure level) in response to the inputted voltage across the audible frequency range. The sound pressure level measured using the T-shaped component of FIG. 17 was 95 dB (+/−5 dB) for frequencies between 600 Hz and 5000 Hz. The sound pressure level measured for this component also increased at a relatively monotonic rate from 60 dB to 90 dB for the frequency range of 0 Hz-600 Hz.

C. Acoustic Member

The acoustic member of the present invention has the capability of producing sound after it is operatively connected to the surface of any piezoelectric component as described in Section B. Alternatively, the acoustic member may be operatively connected to the surface of any transducer capable of producing mechanical vibrations in response to an electrical signal when a substantially flat acoustic response is desired.

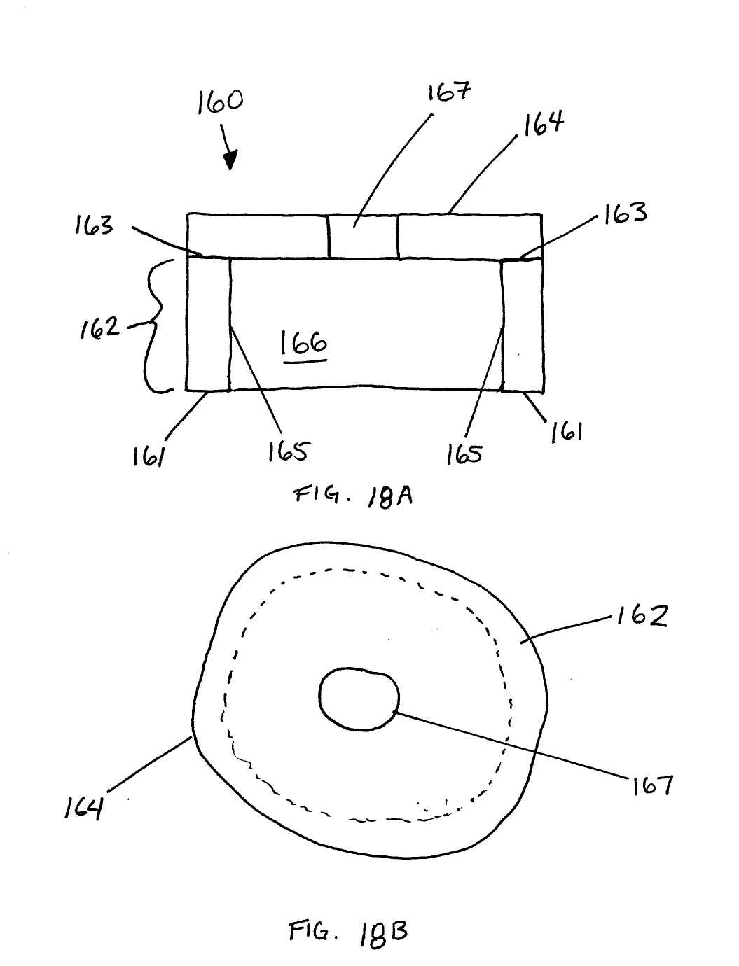

Referring now to FIG. 18A, a cross-sectional view of an acoustic member 160 is shown detailing its basic structure. Essentially, the acoustic member is similar in structure to a bucket or open-ended barrel. The member 160 comprises a surrounding wall portion 162 and an end portion 164. The surrounding wall portion 162 has a bottom surface 161 and a top surface 163. The surrounding wall portion 162 extends in a direction substantially perpendicular from the bottom surface 161 to the top surface 163, thereby creating a surrounding wall 165. The end portion 164 is operatively connected to the surrounding wall portion 162 at the top surface 163 in such a manner as to form a chamber 166 when the member 160 is affixed to the surface of a piezoelectric component.

The end portion 164 further comprises an orifice 167 which forms a passageway through the end portion to the chamber 166. As shown in FIG. 18B, one embodiment of the member 160 has the surrounding wall portion 162 being substantially cylindrical in shape and the end portion 164 being substantially circular. As shown in FIG. 8, the acoustic member 160 may also comprise a box-shaped wall portion and a rectangularly-shaped end portion.

Although the structure of the acoustic member is described as having two portions, it is to be understood that the acoustic member 160 may comprise one unitary structure or article of manufacture. Accordingly, the surrounding wall portion 162 and the end portion 164 may be made and formed from the same material. Plastic is one material which has provided good results, although metallic materials having good structural properties may also be used.

Additionally, it is to be understood that, while the acoustic member has been described as having essentially the shape of a bucket, other shapes or structure which can form a chamber would provide similar results. The acoustic member, by being affixed to the surface of the piezoelectric component, in effect functions in a manner similar to a Helmholtz resonator. Accordingly, other shapes or structure which have the basic structural characteristics of a Helmholtz resonator would provide similar results. Such basic structural characteristics include a chamber or cavity having a predetermined volume and a passageway or neck having a predetermined cross-sectional area and a predetermined neck length. Examples of such shapes or structures include the box-shaped structure of FIG. 8 having six surrounding walls, with one of the surrounding walls having an orifice. Another example would include a hollow spherical structure having an opening at a necked region, known in the art as being a “classical Helmholtz resonator.”

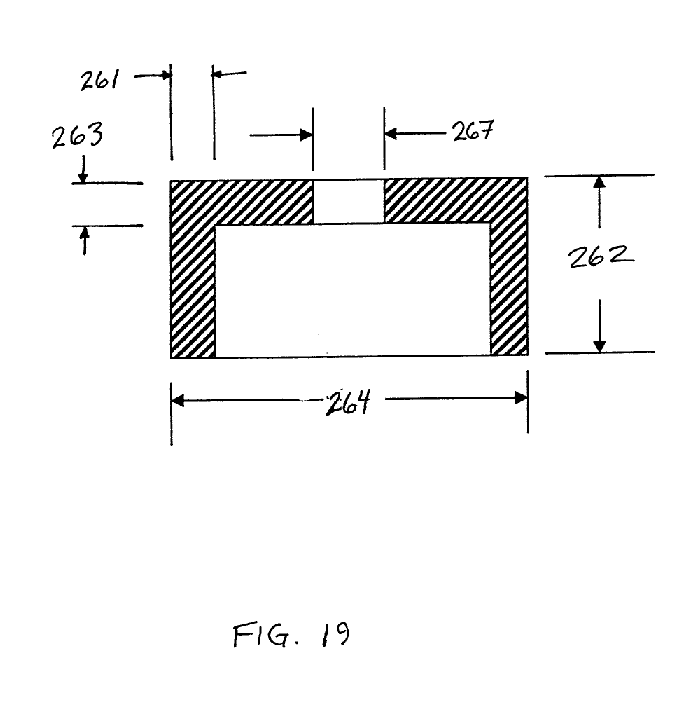

The acoustic chamber 160 generally has several dimensions which may be varied. Referring to FIG. 19, these dimensions include the orifice width 267, the total height of the member 262 (which includes the end portion), and the diameter or girth of the end portion 264. The table below provides examples of the various dimensions which have provided good results. Additionally, the surrounding wall portion 162 and the end portion 164 each have a particular thickness, 261 and 263, respectively. The thickness of the surrounding wall portion 261 may be greater or less than the thickness of the end portion 263, or the thicknesses may be same. In the examples listed in the table below, the wall thicknesses 261 and 263 were all 0.03 in. Generally, the dimensions of the acoustic member (wall thicknesses 261 and 263, member height 262, end portion diameter 264, and orifice size 267) should be selected to produce a resonating frequency that interacts with one of the resonating frequencies of the piezoelectric component. Again, one object of the invention is to produce a substantially flat audio output (i.e., sound pressure level) in response to the inputted voltage across the audible frequency range.

| | Dimensions | | |
|---|---|---|---|
| Example | 262 (in.) | 264 (in.) | 267 (in.) |
| A | 0.1 | 0.2 | 0.01 |
| B | 0.1 | 0.3 | 0.01 |
| C | 0.1 | 0.3 | 0.075 |

The sound waves emanating from the acoustic member are produced by a collection of the out-of-plane displacements of the component. The displacement of each acoustic member causes air to pass through its orifice. The sound range of an acoustic member is dependent upon its physical dimensions and its location on the piezoelectric component. Some of the dimensions of an acoustic member which affect the sound produced include the orifice size (both diameter and depth), the volume of the chamber, and the material being used. The location of the acoustic member on the piezoelectric component determines which mode shapes will influence the acoustic member's displacement (both in amplitude and in frequency).

The sound of each acoustic member is independent of any other acoustic member affixed to the piezoelectric component. When more than one member is used, the sound coalesces to create a rich, full blend. Hence, using more than one acoustic member should result in a greater sound pressure level and a fuller audible range for the multi-functional transducer being used.

D. Operation of the Invention

The transducer assemblies (100a, 100b, or 100c) are all adapted to provide vibrational (tactile) alert, acoustic (sound) alert, and full-range audible sound over the audible frequency range. Accordingly, the processor 16 is designed to output vibrational and acoustic signals 17. When the processor transmits an electrical signal for tactile alert, it transmits an alternating voltage signal at a predetermined first frequency of approximately 300 Hz or less. It is to be understood that an “alternating voltage” signal may be a standard AC signal or a switched DC signal (such as a square wave or the like). When the processor determines to transmit an electrical signal for audio alert, it transmits an alternating voltage signal at a second predetermined range of frequencies between approximately 300 Hz and 12,000 Hz. This particular signal is transmitted either to the transducer assembly (100a, 100b, or 100c) or, if being used, the audible alerting component 26. When the processor 16 determines to transmit electrical signals corresponding to sounds over the broad range of audible frequencies, it transmits these signals to the transducer assembly for sound production. The voltage level needed to vibrate the transducer depends on the thickness of the piezoceramic wafer and preferably ranges from 20 to 120 volts. Typically, the power supply 18 has an output from 1.5 to 10 volts. Higher or lower voltages may also be used.

### EXAMPLES OF THE BEST MODE FOR CARRYING OUT THE INVENTION

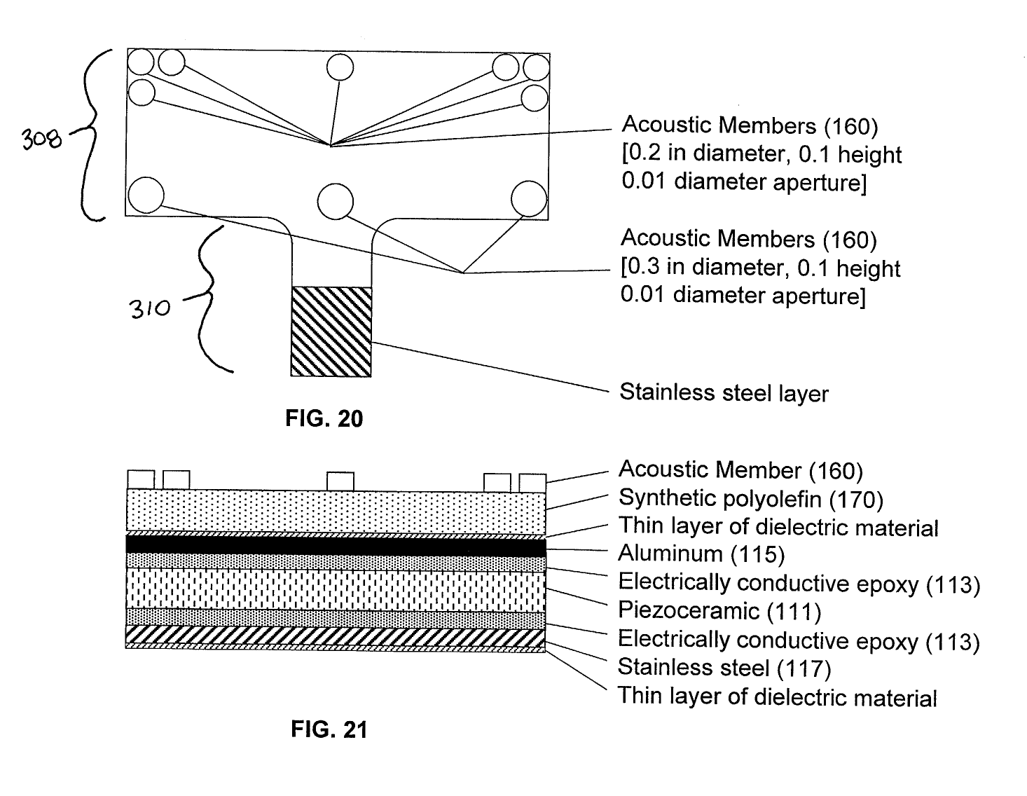

FIG. 20 illustrates a first example for carrying out a multi-functional transducer to generate a tactile alert, an audible alert, and sound over the audible frequency range. The transducer comprises a bimorph piezoelectric component having a T-shaped planform. The cross bar region 308 had a width of 1.75 inches and a length of 1.0 inches extending from the neck region 310. The neck region was 0.5 inch wide and 0.5 inch long. The neck region was reinforced with a 1 mil layer of stainless steel extending 0.25 inch beyond the neck region.

The transducer assembly of the first example was laminated as follows from its top surface to its bottom surface:

Acoustic Members

Adhesive synthetic polyolefin (3M Scotch™ 859 Mounting Squares)

1 mil of adhesive Kapton®V film (as a dielectric material for electrical insulation)

1 mil of aluminum (supporting layer)

1 mil of electrically conductive epoxy

4 mil of a piezoceramic (PZT)

1 mil of electrically conductive epoxy

1 mil of stainless steel (supporting layer)

1 mil of conductive epoxy

4 mil of PZT

1 mil of conductive epoxy

1 mil of aluminum (supporting layer)

1 nmil of adhesive Kapton®g film (as a dielectric)

As illustrated in FIG. 20, the acoustic members are made of the two sizes A and B previously listed in the table of examples. Seven members of size A and three members of size B were positioned at the locations indicated in FIG. 20.

When the piezoelectric transducer is used primarily to generate sound over the audible frequency range, then an alternative best mode is a unimorph structure as shown in FIG. 21. With this second example, the piezoelectric component has the same T-shaped planform as described for the first example and illustrated in FIG. 20. The layered unimorph structure is laminated, however, as indicated in FIG. 21. The thickness of the PZT layer is 8 mil. All other layers of the piezoelectric component are the same thickness as the thicknesses described previously in the first example.

Following from the above description, it should be apparent to those of ordinary skill in the art that, while the designs and operations herein described constitutes several embodiments of the present invention, it is to be understood that the invention is not limited to these precise designs and operations, and that changes may be made therein without departing from the scope of the invention.

What is claimed is:

1. A device comprising:
a housing;
a receiver component, mounted within the housing, for receiving signals transmitted to the device;
a processor, mounted within the housing and operatively coupled to the receiver component, for processing signals received by the receiver component; and
a multi-functional piezoelectric transducer, electrically connected to the processor and mounted within the housing, for producing mechanical vibrations in response to electrical signals transmitted by the processor over a broad range of frequencies, said mechanical vibrations having sufficient force to generate a tactile alert at a predetermined first frequency, to generate an audible alert, and to generate audible sound over the audible frequency range.

2. The device of claim 1 wherein the processor further comprises a power supply for supplying a voltage sufficient to cause the multi-functional piezoelectric transducer to vibrate at the first predetermined frequency and at frequencies within the audible frequency range.

3. The device of claim 2 wherein the first predetermined frequency is less than approximately 300 Hz.

4. The device of claim 2 wherein the range of frequencies for audible alert is between approximately 300 Hz and 12,000 Hz.

5. The device of claim 2 further comprising an output, connected to the housing and operatively coupled to the processor, for visually displaying signals processed by the processor.

6. The device of claim 2 further comprising an amplifier, operatively coupled to the processor, for amplifying electrical signals transmitted by the processor before input to the multi-functional piezoelectric transducer.

7. The device of claim 2 further comprising a user control, operatively connected to the processor, for selecting the type of alert given to a user of the device.

8. The device of claim 1 further comprising a clamp, positioned at at least one end of the multi-functional piezoelectric transducer, for mounting the transducer within the housing.

9. The device of claim 8 wherein the multi-functional transducer is mounted in a cantilever fashion.

10. The device of claim 1 wherein the multi-functional piezoelectric transducer comprises a piezoceramic wafer.

11. The device of claim 10 wherein the piezoceramic wafer comprises at least one layer of lead zirconate titanate (PZT).

12. The device of claim 1 wherein the piezoelectric transducer is selected from the group consisting of a unimorph and a bimorph.

13. The device of claim 10 wherein the piezoelectric transducer is selected from the group consisting of a prestressed unimorph and a prestressed bimorph.

14. The device of claim 1 wherein the piezoelectric transducer further comprises at least one acoustic member attached to one side of the piezoelectric transducer.

15. The device of claim 14 wherein each acoustic member is positioned on an anti-node of the piezoelectric transducer.

16. A personal communication device comprising a housing;
means, mounted within the housing, for receiving signals transmitted to the device;
means, mounted within the housing and operatively coupled to the means for receiving, for processing signals received by the means for receiving; and
means, operatively coupled to the means for processing and mounted within the housing, for producing mechanical vibrations, in response to electrical signals transmitted by the means for processing, over a broad range of frequencies, said mechanical vibrations having sufficient force to generate a tactile alert at a predetermined first frequency, to generate an audible alert, and to generate audible sound over the audible frequency range.

17. The device according to claim 16 further comprising a power supply, operatively coupled to the means for processing, for supplying a voltage sufficient to cause the means for producing mechanical vibrations to vibrate at the first predetermined frequency and at frequencies within the audible frequency range.

18. The device of claim 17 wherein the first predetermined frequency is less than approximately 300 Hz.

19. The device of claim 17 wherein the range of frequencies for audible alert is between approximately 300 Hz and 12,000 Hz.

20. The device according to claim 17 further comprising means, connected to the housing and operatively coupled to the processor, for visually displaying signals processed by the means for processing.

21. The device according to claim 17 further comprising means, operatively coupled to the processor, for amplifying electrical signals transmitted by the processor before input to the means for producing mechanical vibrations.

22. The device of claim 17 further comprising means, operatively connected to the processor, for controlling the type of alert selected by a user of the device.

23. The device of claim 16 further comprising a clamp, positioned at one end of the multi-functional means, for mounting the means for producing mechanical vibrations within the housing.

24. The device of claim 23 wherein the means for producing mechanical vibrations is mounted in a cantilever fashion.

25. The device according to claim 16 wherein the means for producing mechanical vibrations comprises a piezoceramic wafer.

26. The device according to claim 25 wherein the piezoceramic wafer comprises at least one layer of lead zirconate titanate (PZT).

27. The device according to claim 16, wherein the means for producing mechanical vibrations is selected from the group consisting of a unimorph and a bimorph.

28. The device according to claim 16 wherein the means for producing mechanical vibrations is selected from the group consisting of a prestressed unimorph and a prestressed bimorph.

29. The device according to claim 16 wherein the means for producing mechanical vibrations further comprises at least one acoustic member connected to one side of the means for producing mechanical vibrations.

30. The device according to claim 29 wherein the at least one acoustic member is positioned on an anti-node of the means for producing mechanical vibrations.

31. A device for producing mechanical vibrations in response to an electrical signal, comprising
a piezoelectric component having two opposing surfaces, said piezoelectric component further having at least two points where polarity is recognized; and
at least one acoustic member attached to one of the surfaces of the piezoelectric component.

32. The device according to claim 31, wherein the piezoelectric component comprises a unimorph piezoelectric structure having one piezoceramic wafer bonded between two metallic support layers.

33. The device according to claim 31, wherein the piezoelectric component comprises a bimorph piezoelectric structure having two piezoceramic wafers, each piezoceramic wafer being bonded to a different surface of a metallic support layer.

34. The device according to claim 32 wherein the piezoceramic wafer is made of lead zirconate titanate (PZT).

35. The device according to claim 33 wherein at least one piezoceramic wafer is made of lead zirconate titanate (PZT).

36. The device according to claim 31 further comprising a dampening material being positioned between the piezoelectric component and each acoustic member.

37. The device according to claim 36 wherein the dampening material substantially covers at least one surface of the piezoelectric component.

38. The device according to claim 31 wherein the piezoelectric component further comprises a neck region extending from one side of the piezoelectric component.

39. The device according to claim 38 further comprising a clamp, connected at the neck region of the piezoelectric component, for coupling the piezoelectric component to a base.

40. The device according to claim 31 wherein the piezo electric component is coupled to a base in a cantilever fashion.

41. The device according to claim 31 further comprising means, positioned at one end of the piezoelectric component, for adjustably connecting the piezoelectric component to a base surface.

42. The device according to claim 31 wherein the at least one acoustic member comprises a surrounding wall portion having a bottom surface and a top surface, the surrounding wall portion extending along a direction substantially perpendicular from the bottom surface to the top surface, the bottom surface being operatively connected to the piezoelectric component.

43. The device according to claim 42 wherein the at least one acoustic member further comprises an end portion, operatively connected to the top surface of the surrounding wall portion, to form an enclosed chamber within the acoustic member when the bottom surface of the acoustic member is connected to the piezoelectric component.

44. The device according to claim 43 wherein the end portion has an orifice to form a passageway through the end portion to the chamber.

45. The device according to claim 31 wherein the mechanical vibrations are of sufficient force to produce audible sound at a predetermined frequency.

46. The device according to claim 31 wherein the mechanical vibrations are of sufficient force to produce audible sound over substantially the entire audible frequency range.

47. The device according to claim 31 wherein the mechanical vibrations are of sufficient force as to be readily felt by a holder of the device.

48. The device according to claim 31 wherein the mechanical vibrations are of sufficient force as to produce an audible alerting signal, a tactile alerting signal, and audible sound over substantially the entire audible frequency range.

49. The device according to claim 31, wherein the point of attachment of the at least one acoustic member is approximately at an anti-node of the piezoelectric component.

50. An article for producing sound comprising:
a surrounding wall portion having a bottom surface and a top surface, the surrounding wall portion extending along a direction substantially perpendicular from the bottom surface to the top surface, the surrounding wall portion having a thickness; and
an end portion, operatively connected to the top surface of the surrounding wall portion to define a surrounded area within the article, the end portion having a thickness, the end portion having an orifice to form a passageway through the end portion to the surrounded area.

51. An article for producing sound according to claim 50 wherein the surrounding wall portion is substantially cylindrical.

52. An article for producing sound according to claim 50 wherein the end portion is substantially circular.

53. An article for producing sound according to claim 50 wherein the surrounding wall portion is made of plastic.

54. An article for producing sound according to claim 50 wherein the end portion is made of plastic.

55. An article for producing sound according to claim 50, wherein the thickness of the surrounding wall portion is greater than the thickness of the end portion.

56. A device comprising:
a housing;
a receiver component, mounted within the housing, for receiving signals transmitted to the wireless or communication line device;
a processor, mounted within the housing and operatively coupled to the receiver component, for processing signals received by the receiver component;
an audible alerting component, mounted within the housing and operatively coupled to the processor, for vibrating at a predetermined first frequency so as to produce an audible, alerting sound; and
a multi-functional piezoelectric transducer, electrically connected to the processor and mounted within the housing, for producing mechanical vibrations, in response to electrical signals transmitted by the processor, over a broad range of frequencies, said mechanical vibrations having sufficient force to generate a tactile alert at a predetermined second frequency and to generate sound over the audible frequency range.

57. The device of claim 56 wherein the processor further comprises a power supply for supplying a voltage sufficient to cause the audible alerting component to vibrate at the first predetermined frequency and to cause the multi-functional piezoelectric transducer to vibrate at the second predetermined frequency and within the audible frequency range.

58. The device of claim 57 wherein the first predetermined frequency is in a range between approximately 300 Hz and 12,000 Hz.

59. The device of claim 57 wherein the second predetermined frequency is less than approximately 300 Hz.

60. The device of claim 57 further comprising an output, connected to the housing and operatively coupled to the processor, for visually displaying signals processed by the processor.

61. The device of claim 57 further comprising an amplifier, operatively coupled to the processor, for amplifying electrical signals transmitted by the processor before input to the audible alerting component and to the multi-functional piezoelectric transducer.

62. The device of claim 57 further comprising a user control, operatively connected to the processor, for selecting the type of alert given to a user of the device.

63. The device of claim 57 further comprising a clamp, positioned at one end of the multi-functional piezoelectric transducer, for mounting the transducer within the housing.

64. The device of claim 63 wherein the multi-functional piezoelectric transducer is mounted in a cantilever fashion.

65. The device of claim 57 wherein the multi-functional piezoelectric transducer comprises a piezoceramic wafer.

66. The device of claim 65 wherein the piezoceramic wafer comprises at least one layer of lead zirconate titanate (PZT).

67. The device of claim 57 wherein the multi-functional piezoelectric transducer is selected from the group consisting of a unimorph and a bimorph.

68. The device of claim 57 wherein the multi-functional piezoelectric transducer is selected from the group consisting of a prestressed unimorph and a prestressed bimorph.

69. The device of claim 57 wherein the multi-functional piezoelectric transducer further comprises at least one acoustic member attached to one side of the piezoelectric transducer.

70. The device of claim 69 wherein each acoustic member is positioned on an anti-node of the piezoelectric transducer.

71. A personal communication device comprising:
a housing;
a receiver component, mounted within the housing, for receiving signals transmitted to the device;
a processor, mounted within the housing and operatively coupled to the receiver component, for processing signals received by the receiver component; and
a multi-functional piezoelectric transducer, electrically connected to the processor and mounted within the housing, for producing mechanical vibrations in response to electrical signals transmitted by the processor over a broad range of frequencies, the multi-functional piezoelectric transducer comprising a piezoelectric component having two opposing surfaces, said piezoelectric component further having at least two points where polarity is recognized, the multi-functional piezoelectric transducer further comprising at least one acoustic member attached to one of the surfaces of the piezoelectric component, said at least one acoustic member forming a chamber after being attached to the surface of the piezoelectric component,
whereby said mechanical vibrations of the multi-functional transducer have sufficient force to generate a tactile alert at a predetermined first frequency, to generate an audible alert, and to generate audible sound over the audible frequency range.

72. A personal communication device comprising:
a housing;
a receiver component, mounted within the housing, for receiving signals transmitted to the device;
a processor, mounted within the housing and operatively coupled to the receiver component, for processing signals received by the receiver component;
a multi-functional piezoelectric transducer, electrically connected to the processor and mounted within the housing, for producing mechanical vibrations in response to electrical signals transmitted by the processor over a broad range of frequencies; and,
a clamp, positioned at one end of the multi-functional piezoelectric transducer, for mounting the transducer within the housing,
whereby said mechanical vibrations have sufficient force to generate a tactile alert, an audible alert, and audible sound over the audible frequency range.
